(19) United States
(12) Patent Application Publication
(10) Pub. No.: US 2026/0340334 A1
(43) Pub. Date: Oct. 29, 2026

(54) DEVICES, SYSTEMS, AND METHODS FOR WIRELESSLY RECONFIGURING A PAYMENT CARD

(71) Applicant: Visa International Service Association, San Francisco, CA (US)

(72) Inventor: Yuexi Chen, Foster City, CA (US)

(73) Assignee: Visa International Service Association, San Francisco, CA (US)

(21) Appl. No.: 19/123,114

(22) PCT Filed: Nov. 14, 2022
(86) PCT No.: PCT/US2022/079831

§ 371 Date: Apr. 22, 2025

(51) Int. Cl. G06K 19/07; G06F 8/65

(52) U.S. Cl. CPC G06K 19/0701; G06F 8/65

(57) ABSTRACT

A payment card configured to be wirelessly reconfigured is disclosed herein. The payment card can include a charging coil configured to generate electrical energy in response to a magnetic field generated by a corresponding charging coil of a computing device, and a wireless communication component electrically coupled to the charging coil, wherein the charging coil is configured to power the wireless communication circuit to communicate with the computing device via a wireless communication protocol.

### FIELD

At least some aspects of the present disclosure relate to reconfigurable cards, including payment cards, which can be removably attachable to a portable electronic device and, after attachment, are configured to receive configuration updates from the portable electronic device.

### SUMMARY

The following summary is provided to facilitate an understanding of some of the innovative features unique to the aspects disclosed herein, and is not intended to be a full description. A full appreciation of the various aspects can be gained by taking the entire specification, claims, and abstract as a whole.

In various aspects, a payment card configured to be wirelessly reconfigured is disclosed. The payment card can include a charging coil configured to generate electrical energy in response to a magnetic field generated by a corresponding charging coil of a computing device, and a wireless communication component electrically coupled to the charging coil, wherein the charging coil is configured to power the wireless communication circuit to communicate with the computing device via a wireless communication protocol.

In various aspects, a method of wirelessly reconfiguring a payment card is disclosed. The method can include aligning, via an alignment component of the payment card, a charging coil of the payment card with a corresponding charging coil of an external power source, receiving, via the charging coil of the payment card, electrical energy from the corresponding charging coil of the external power source, providing, via a wireless charging component of the payment card, the received electrical energy to a wireless communications component of the payment card, coupling the wireless communications component of the payment card to a computing device, receiving, via the wireless communications component of the payment card, a communication from the computing device, and reconfiguring, via a programmable component of the payment card, the payment card based on the received communication from the computing device ..

In various aspects, a system for wirelessly reconfiguring a payment card is disclosed. The system can include a computing device including a processor and a memory configured to store an application that, when executed by the processor, causes the computing device to detect an available configuration update, and a payment card, wherein the payment card includes a charging coil configured to generate electrical energy in response to a magnetic field generated by the computing device, a wireless communication circuit electrically coupled to the charging coil, wherein the charging coil is configured to power the wireless communication circuit to receive the detected configuration update from the computing device via a wireless communication protocol, and a programmable component reconfigurable by the configuration update.

These, and other objects, features, and characteristics of the present disclosure, as well as the methods of operation, and functions of the related elements of structure, and the combination of parts, and economies of manufacture, will become more apparent upon consideration of the following description, and the appended claims with reference to the accompanying drawings, all of which form a part of this specification, wherein like reference numerals designate corresponding parts in the various figures. It is to be expressly understood, however, that the drawings are for the purpose of illustration, and description only, and are not intended as a definition of the limits of the disclosure.

### BRIEF DESCRIPTION OF THE DRAWINGS

Various features of the aspects described herein are set forth with particularity in the appended claims. The various aspects, however, both as to organization, and methods of operation, together with advantages thereof, may be understood in accordance with the following description taken in conjunction with the accompanying drawings as follows:

The apparatuses and methods disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIGS. 1A-1B illustrate a perspective view of a system for wirelessly reconfiguring a payment card, in accordance with at least one non-limiting aspect of the present disclosure;

FIG. 2 illustrates a sectioned top view of the payment card of the system of FIGS. 1A and 1B, in accordance with at least one non-limiting aspect of the present disclosure;

FIG. 3 illustrates a simplified representation of a wireless charging system incorporating a ferromagnetic component disposed about a charging coil, in accordance with at least one non-limiting aspect of the present disclosure;

FIG. 4 illustrates a portable electronic device including various components of a wireless charging system, in accordance with at least one non-limiting aspect of the present disclosure;

FIG. 5 illustrates a payment card configured for removable attachment to the portable electronic device of FIG. 4, in accordance with at least one non-limiting aspect of the present disclosure;

FIGS. 6A and 6B illustrate an alignment of the payment card of FIG. 5 relative to the portable electronic device of FIG. 5, in accordance with at least one non-limiting aspect of the present disclosure;

FIGS. 7A-7D illustrate several payment cards with various magnet arrays, in accordance with at least several non-limiting aspects of the present disclosure;

FIGS. 8A and 8B illustrate several payment cards having multiple layers, in accordance with at least several non-limiting aspects of the present disclosure;

FIGS. 9A-9C illustrate several cross-sectional views of several magnet embedding configurations, in accordance with several non-limiting aspects of the present disclosure;

FIG. 10 illustrates a simplified block circuit diagram of a card and a portable electronic device, in accordance with at least one non-limiting aspect of the present disclosure;

FIG. 11 illustrates a diagram of an example payment network environment in which a reconfigurable card may be used to conduct a transaction, in accordance with at least one non-limiting aspect of the present disclosure;

FIG. 12 illustrates a circuit schematic of a reconfigurable card, in accordance with at least one non-limiting aspect of the present disclosure;

FIG. 13 illustrates a circuit schematic of a wireless communications component, in accordance with at least one non-limiting aspect of the present disclosure; and

FIG. 14 illustrates a logic flow diagram of a method of wirelessly reconfiguring a payment card, in accordance with at least one non-limiting aspect of the present disclosure.

Corresponding reference characters indicate corresponding items throughout the several views. The exemplifications set out herein illustrate various aspects of the present disclosure, in one form, and such exemplifications are not to be construed as limiting the scope of the present disclosure in any manner.

### DETAILED DESCRIPTION

Before explaining various forms of the payment card, it should be noted that the illustrative forms disclosed herein are not limited in application or use to the details of construction and arrangement of components illustrated in the accompanying drawings and description. The illustrative forms may be implemented or incorporated in other forms, variations and modifications, and may be practiced or carried out in various ways. Further, unless otherwise indicated, the terms and expressions utilized herein have been chosen for the purpose of describing the illustrative forms for the convenience of the reader and are not for the purpose of limitation thereof. Also in the following description, it is to be understood that terms such as “forward,” “rearward,” “left,” “right,” “above,” “below,” “upwardly,” “downwardly,” and the like are words of convenience and are not to be construed as limiting terms.

A “payment card” can refer to any device that may be used to conduct a transaction, such as a financial transaction. For example, a payment card may be used to provide payment information to a merchant. A payment card can include a substrate such as a paper, metal, or plastic card, and information that is printed, embossed, encoded, and/or otherwise included at or near a surface of the payment card. A payment card can be hand-held and compact so that it can fit into a consumer's wallet and/or pocket (e.g., pocket-sized). A payment card can be a smart card, a debit device (e.g., a debit card), a credit device (e.g., a credit card), a stored value device (e.g., a stored value card or “prepaid” card), a magnetic stripe card, a security card, an access card, a memory card, and/or an identification card, among others. A payment card may operate in a swipe, contact and/or contactless mode. For example, a payment card may be an electronic payment device, such as a smart card, a chip card, an integrated circuit card, and/or a near field communications (NFC) card, among others. An electronic payment device may include an embedded integrated circuit and the embedded integrated circuit may include a data storage medium (e.g., volatile and/or non-volatile memory) to store information associated with the electronic payment device, such as an account identifier and/or a name of an account holder. A payment card may interface with an access device such as a point of sale device to initiate the transaction.

An “access device” may refer to a device that receives information from a payment card to initiate a transaction. For example, an access device may be a point of sale device configured to read account data encoded in a magnetic stripe or chip of a payment card. Other examples of access devices include cellular phones, personal computers, tablets, handheld specialized readers, set-top boxes, electronic cash registers, automated teller machines (ATMs), virtual cash registers, kiosks, security systems, access systems, and the like. Access devices may use means to interact with a payment card, such as NFC, Bluetooth® low-energy (“BLE”), radio frequency (RF), optical readers, and/or magnetic stripe readers.

As used herein, a “portable electronic device” may refer to any electronic device that is portable and operated by user. Examples of portable electronic devices include smartphones and other mobile phones (e.g., cellular phones), tablet computers, laptop computers, netbooks, personal music players, e-readers, hand-held specialized readers, mobile Wi-Fi devices, handheld gaming systems, navigation systems, storage devices, portable media players, wearable devices (e.g., fitness bands, smart watches, headphones, earbuds), various electronic devices included in automobiles, and any other electronic device that a user may transport, carry, and/or wear. Other portable electronic devices can include robotic devices, remote-controlled devices, personal-care appliances, and so on.

Modern consumers benefit from a variety of ways to pay for goods or services. In fact, the number of cards, accounts and apps available for consumer use in various scenarios is only growing. For example, the modern consumer may choose to pay for goods or services via a debit card, a credit card, a person-to-person payment means, a health savings account, a loyalty rewards card, and/or a cryptocurrency, depending on a particular situation and/or preference. However, having all various payment methods readily available means that consumers will have to carry an overwhelming about of cards, wherein each card is associated with a particular means of payment.

In response to this problem, programmable payment technologies have been emerging to streamline a consumer's payment process without compromising the consumer's flexibility. For example, programmable cards such as the Fuze Card by BrilliantTS, aspires to consolidate multiple payment accounts (e.g., a debit account, a credit account, a loyalty account, etc.) onto a single card. However, such cards require electrical power and thus, necessitate an on-board power source, such as a battery. It shall be appreciated that on-board power sources add expense to the cards by increasing material costs and the cost of manufacture. Moreover, such power sources limit the usable life of a card and could worsen the environmental impact of the card. Accordingly, there is a need for improved devices, systems, and methods for wirelessly reconfiguring a payment card.

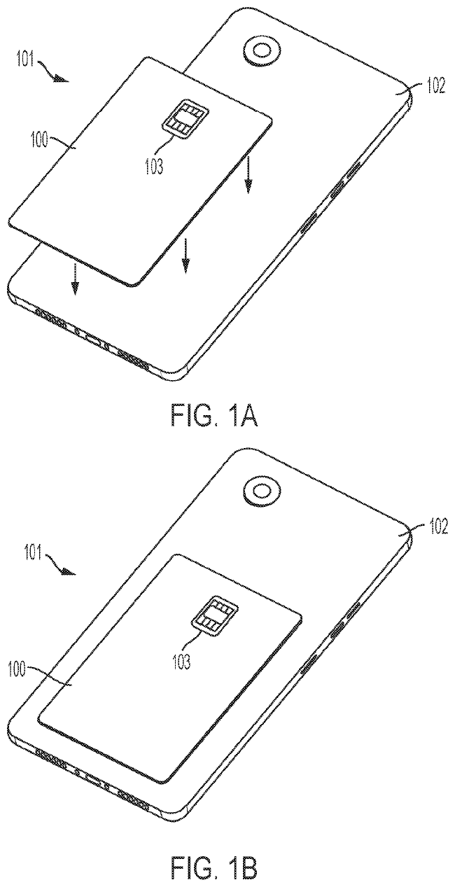

Referring now to FIGS. 1A and 1B, a perspective view of a system 101 for wirelessly reconfiguring a payment card 100 is depicted in accordance with at least one non-limiting aspect of the present disclosure. Although the present disclosure will discuss the non-limiting aspect of FIGS. 1A and 1B in reference to a payment card 100, it shall be appreciated that, according to other non-limiting aspects, the system 101 can be similarly applied to wirelessly reconfigure any card, including a debit card, a credit card, a membership card, an identification card, a health savings account card, a loyalty rewards card, and/or a cryptocurrency card, amongst others. As such, the non-limiting aspects of FIGS. 1A and 1B are merely illustrative. According to other non-limiting aspects, the system 101 can be applied to wirelessly reconfigure a single card to function as any of the aforementioned cards, including a debit card, a credit card, a membership card, an identification card, a health savings account card, a loyalty rewards card, and/or a cryptocurrency card, amongst others. For example, according to such aspects, a user need only carry a single card, which can be reconfigured via a computing device, such as the portable electronic device 102 of FIGS. 1A and 1B.

In further reference to FIGS. 1A and 1B, the system 101 enables the payment card 100 to be removably attached to a computing device, such as a portable electronic device 102. For example, according to the non-limiting aspect of FIGS. 1A and 1B, the payment card 100 can be removably attached to the portable electronic device 102 via magnetic coupling. However, it shall be further appreciated that both the removable attachment—and means of removable attachment—of the payment card 100 are non-limiting. For example, according to some non-limiting aspects, the payment card 100 can be removably attached to the portable electronic device 102 via a sleeve that can be adhesively attached to the portable electronic device 102. According to other non-limiting aspects, the payment card 100 can be inserted or otherwise integrated into a case configured to at least partially envelope and/or protect the portable electronic device 102. Regardless, the system 101 of FIGS. 1A and 1B enables the payment card 100 to transition between a condition where it is unattached to the portable electronic device 102, as depicted in FIG. 1A, and a condition where it is attached to the portable electronic device 102, as depicted in FIG. 1B.

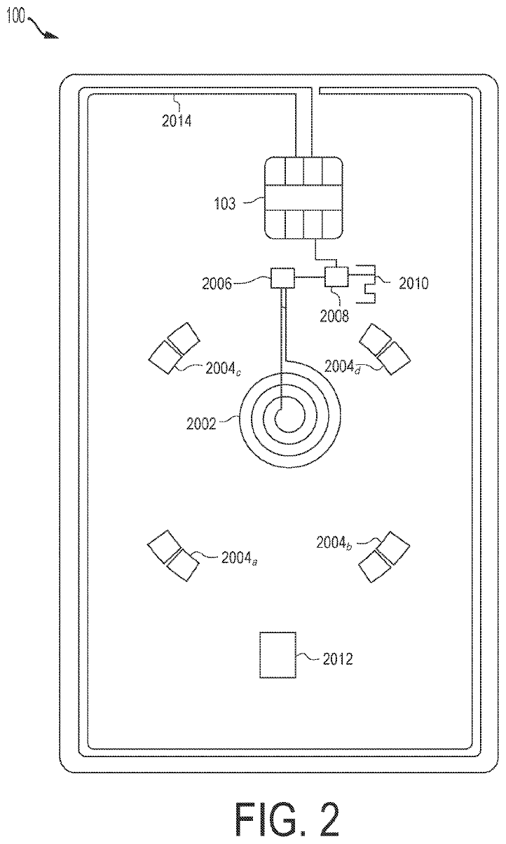

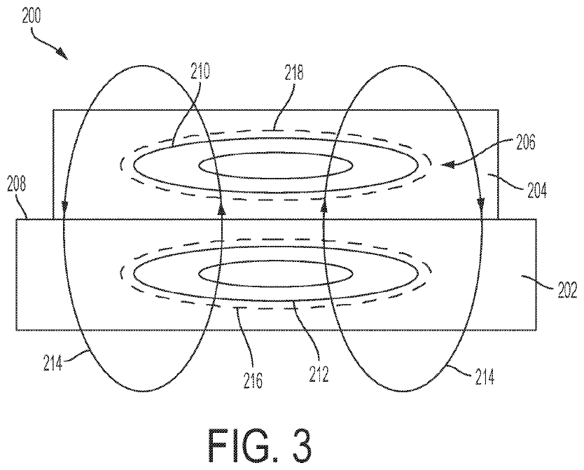

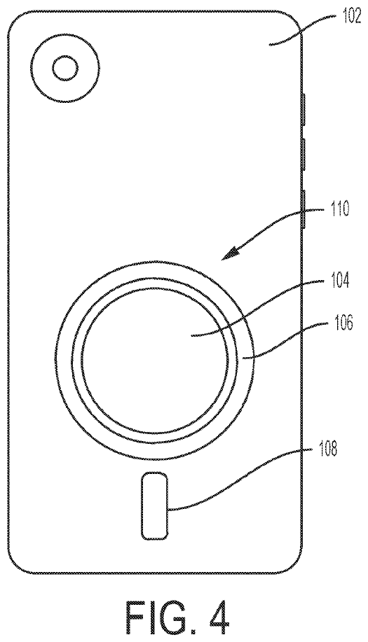

Specifically, according to the non-limiting aspect of FIGS. 1A and 1B together with FIGS. 2-4, the payment card 100 can include one or more magnets 2004_{a-d} (FIG. 2) configured to magnetically couple the payment card 100 to a ferromagnetic component 106 (FIG. 3) of the portable electronic device 102. According to some non-limiting aspects, the ferromagnetic component 106 of the portable electronic device 102 may be part of a wireless charging system, for example. FIGS. 3 and 4 and the accompanying description below provide examples of wireless charging systems in portable electronic devices. In other words, merely positioning the payment card 100 proximal to the portable electronic device 102 (as shown in FIG. 1A) can cause the payment card 100 to removably attach to a surface of the portable electronic device 102 (as shown in FIG. 1B) via the one or more magnets 2004_{a-d} of the payment card 100 and the ferromagnetic component 106 of the portable electronic device 102. The magnetic coupling force between the payment card 100 and the portable electronic device 102 can be optimized to both: (i) allow an intended detachment of the payment card 100 from the portable electronic device 102, and (ii) prevent/resist an unintended detachment of the payment card 100 (e.g., when the portable device 102 is slid into or out of a user's pocket). This can allow the payment card 100 to be quickly and easily accessed by a user for providing payment to a merchant, for example. Moreover, the payment card 100 may add only a relatively minimal thickness (e.g., no greater than 0.76 mm) when removably attached to the portable electronic device 102. Accordingly, the portable electronic device 102 and the payment card 100 can be more easily stored by a user (e.g., in the user's pocket) compared to a portable electronic device 102 that is attached to a bulky card holder, case, or wallet accessory.

As yet another example, the payment card 100 can encourage users to conduct more financial transactions using the payment card 100. This can provide business-related benefits to a supplier of the payment card 100 and/or a financial institution associated with the payment card 100. For example, as discussed above, users frequently carry their portable electronic devices with them whenever they leave their home. Enabling the payment card 100 to removably attach to the portable electronic device 102 would encourage users to bring the payment card 100 with them anytime they carry their portable electronic device 102, even in situations where users might have otherwise decided not to bring the payment card 100. Furthermore, as shown in FIG. 1B, the payment card 100 is visible when removably attached to the portable electronic device 102. Accordingly, users of the portable electronic device 102 may be frequently reminded of the payment card 100 and therefore may be more likely to conduct a transaction using the payment card 100.

Regardless of the particular means of removable attachment, it shall be further appreciated that the payment card 100 of the system 101 of FIGS. 1A and 1B, together with FIGS. 2 and 3, can be removably attached to the portable electronic device 102 such that a component of the payment card 100 is particularly aligned with a corresponding component of the portable electronic device 102. For example, according to the non-limiting aspect of FIGS. 1A and 1B, it may be particularly beneficial for a charging coil 2002 (FIG. 2) of the payment card 100 to be aligned with a charging coil 210 (FIG. 3) of a portable electronic device.

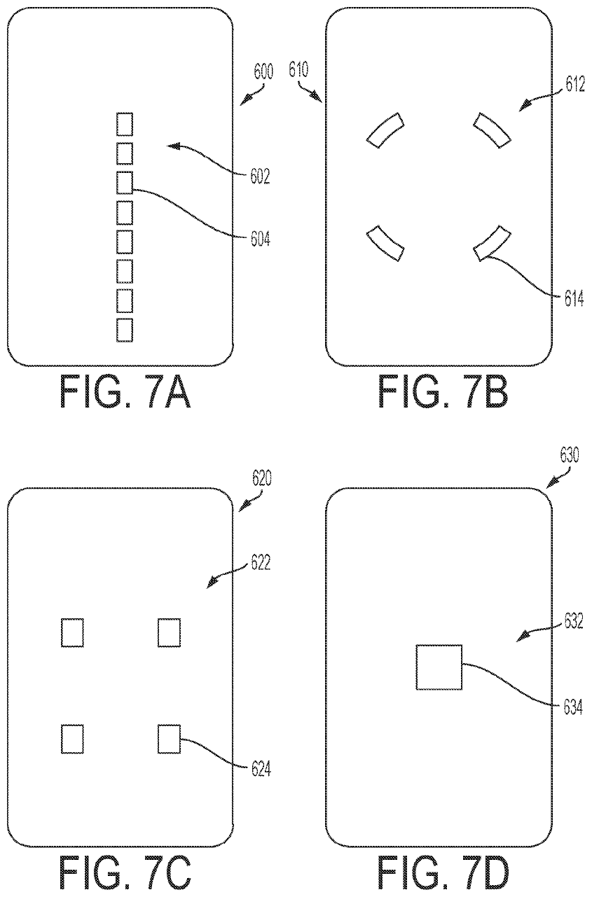

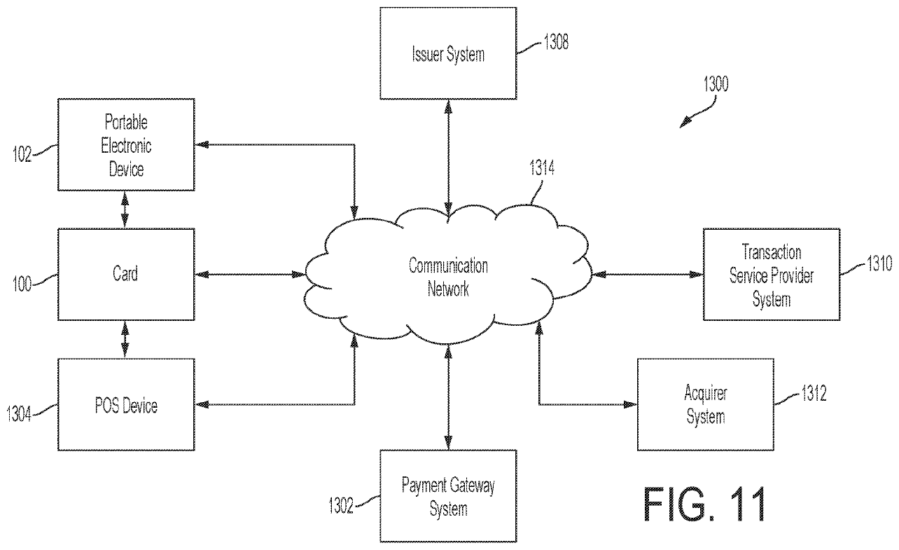

As will be described in further detail with reference to FIG. 2, the payment card 100 of FIG. 1 can further include one or more programmable components 103, including a integrated circuit (e.g., an Europay, MasterCard® and Visa® (“EMV”) chip, etc.), a magnetic stripe, a radio-frequency identification (“RFID”) chip, and/or a near-field communication (“NFC”) chip, amongst others. For example, a programmable component, such as the chip 103 of the payment card 102 of FIGS. 1A and 1B can be configured and/or reconfigured to store account information associated with one or more user accounts (e.g. a debit account, a credit account, a membership account, an identification credential, a health savings account, a loyalty rewards account, and/or a cryptocurrency account, etc.) in response to a configuration update. According to some non-limiting aspects, the configuration update can be transmitted by the portable electronic device 102. It shall be further appreciated that, according to various aspects, the card 100 can be configured for contact-based payments (e.g., wherein the EMV circuit 103 is inserted into a POS device 1304 (FIG. 11) or a magnetic stripe is read by a POS device 1304 (FIG. 11), etc.) and/or contactless payments (e.g., via a signal transmission via an antenna, such as the NFC antenna 742 (FIG. 7B), etc.).

Referring now to FIG. 2 together with FIGS. 1A, 1B and 3, a sectioned top view of the payment card 100 of the system 101 of FIGS. 1A and 1B is depicted in accordance with at least one non-limiting aspect of the present disclosure. As previously discussed, the payment card 100 can include a wireless charging coil 2002, one or more programmable components 103, and one or more magnets 2004_{a-d} configured to secure the payment card 100 to a ferromagnetic component 106 (FIG. 3) of the portable electronic device 102 (FIGS. 1A and 1B). However, according to the non-limiting aspect of FIG. 2, the payment card 100 can further include a wireless charging component 2006, a wireless communications component 2008, a wireless antenna 2010, an alignment component 2012, and/or a transaction antenna 2014. Specifically, FIG. 2 depicts components of the payment card 100 that enable the payment card 100 to be wirelessly reconfigured without the need of an on-board power source, such as a battery. Accordingly, the payment card 100 of FIGS. 1A, 1B, and 2 can cost less, be more efficient to manufacture, and may have a longer usable life and an improved environmental impact, when compared to battery-powered cards with comparable functionality.

Specifically, the wireless charging component 2006 of the payment card 100 of FIG. 2 can be electrically coupled to the charging coil 2002. Therefore, when the payment card 100 is removably attached to the portable electronic device 102 (FIGS. 1A and 1B), the wireless charging coil 2002 can be aligned with and placed in proximity to the charging coil 210 (FIG. 3) of the portable electronic device 102 (FIGS. 1A and 1B) and thus, the payment card 100 can be inductively coupled to a power source of the portable electronic device 102. The alignment component 2012 can include a magnet, for example, that is configured to ensure that the payment card 100 is not just removably attached to the portable electronic device 102 but properly aligned relative to the portable electronic device 102. As such, energy can be transferred from a power source of the portable electronic device 102 via the charging coil 210 (FIG. 3) of the portable electronic device 102, and into the charging coil 2002 of the payment card 100 of FIG. 2 via a magnetic field that creates an alternating electric current when the system 101 (FIGS. 1A and 1B) is inductively coupled. In other words, the wireless charging coil 2002 can enable the payment card 100 to draw electrical power from portable electronic device 102 via reverse wireless charging.

Still referring to FIG. 2 together with FIGS. 1A, 1B, and 3, the electrical power drawn from the portable electronic device 102 (FIGS. 1A and 1B) can be regulated by the wireless charging component 2006, which can supply the electrical power to various components of the payment card 100, including the wireless communications component 2008, the wireless antenna 2010, and/or the programmable component 103, itself. Notably, electrical power drawn from the portable electronic device 102 can be used to power the wireless communications component 2008. According to some non-limiting aspects, the wireless charging component 2006 can be configured to temporarily store electrical power drawn from the portable electronic device 102. For example, the wireless charging component 2006 may include a capacitor and/or any additional component configured to store or supply electrical power drawn from the portable electronic device 102. As such, according to such non-limiting aspects, that the payment card 100 is powered for a certain period of time upon separation of the charging coil 2002 of the payment card 100 and the charging coil 210 (FIG. 3) of the portable electronic device 102.

With continued reference to FIG. 2 together with FIGS. 1A and 1B, the wireless communications component 2008 of the payment card 100 of FIG. 2 can be configured to establish a low-power, low-data network, including Bluetooth® low-energy (“BLE”), Zigbee, Z-Wave, and/or 6LoWPAN, amongst others. In other words, the wireless communications component 2008 of the payment card 100 can be communicably coupled with an application and/or application program interface (“API”) executed and/or otherwise accessed by the portable electronic device 102 (FIGS. 1A and 1B). According to some non-limiting aspects, the wireless communications component 2008 can accomplish this in conjunction with the wireless antenna 2010 of the payment card 100. However, according to other non-limiting aspects, the wireless communications component 2008 can constitute an integrated circuit that includes the wireless antenna 2010. As such, it shall be appreciated that the present disclosure contemplates alternate circuit configurations.

With continued reference to FIG. 2 together with FIGS. 1A and 1B, the payment card 100 of FIG. 2—and more particularly, the charging coil 2002 and wireless charging component 2006—can be used to power the wireless communications component 2008 without requiring a battery. Upon receiving power from the wireless charging component 2006, the wireless communications component 2008 of the payment card 100 can establish a wireless connection (e.g., a BLE connection, etc.) with the portable electronic device 102 (FIGS. 1A and 1B) and subsequently send and/or receive communications from an application and/or API executed or otherwise accessed by the portable electronic device 102 or any other back-end source or destination for communications. For example, according to some non-limiting aspects, the application and/or API can communicably couple the wireless communications component 2008 of the payment card 100 with the portable electronic device 102 via a “pairing” process, wherein the portable electronic device 102 searches for a powered wireless communications component 2008 upon detection. Alternately and/or additionally, once the portable electronic device 102 locates the powered wireless communications component 2008, a user of the portable electronic device 102 may have to select the payment card 100 from a list of detected devices via a user interface of the application and/or API.

With continued reference to FIG. 2 together with FIGS. 1A and 1B, it shall be appreciated that the payment card 100 of FIG. 2 can communicate with the portable electronic device 102 (FIGS. 1A and 1B). Such communications can include a variety of messages, commands, and/or configuration updates, amongst other communications relevant to the payment card 100. For example, such communications can include a command to store, alter, and/or remove data from the programmable component 103 of the payment card 100. According to some non-limiting aspects, the payment card 100 can receive one or more configuration updates from the portable electronic device 102, wherein the configuration update causes the programmable component 103—and thus, the payment card 100, itself—to function in a particular manner. According to some non-limiting aspects, the application and/or API can generate and/or detect one or more configuration updates for the payment card 100. According to other non-limiting aspects, the application and/or API can be configured to receive a user input via a user interface of the portable electronic device 102, wherein the user input causes the application and/or API to transmit a desired configuration update to the wireless communications component 2008 of the payment card 100. The configuration update can enable a certain feature of the payment card 100, disable a certain feature of the payment card 100, change a priority of the payment card 100, and/or change a spending limit of the payment card 100, amongst other configuration changes. The communications can be wrapped in data packets and transmitted to the wireless communications component 2008, which can be configured to unwrap the received data packets and forward them to the programmable component 103 for processing. The programmable component 103 can wrap a response in a data packet for transmission to the portable electronic device 102 via the wireless communications component 2008, in turn.

With continued reference to FIG. 2 together with FIGS. 1A and 1B, in other words, the payment card 100 of FIG. 2 is particularly configured to communicate with and thus, receive communications from, the portable electronic device 102 (FIGS. 1A and 1B).

According to some non-limiting aspects, such communications can include any known Application Protocol Data Unit (“APDU”) commands. It shall be appreciated that APDU is a command/response protocol for invoking functions executed on a smart card or similar device. It shall be appreciated that APDU is a standard communication messaging protocol between a card accepting device and a card, such as a “smart” card. Such APDU commands can include, for example, a 4-byte header (CLA, INS, P1, P2) and from 0 to 65 535 bytes of data. For example, the configuration update can include a STORE DATA command that, according to some non-limiting aspects, can store data transmitted by the portable electronic device 102 via the programmable component 103 of the payment card 100. This can include a token and/or a limited usage key, amongst other commands, either of which can be encrypted or signed in accordance with user preference and/or intended application. According to other non-limiting aspects, the configuration update can include a PUT DATA command configured to write type-length-value (“TLV”) coded data objects. which can include a signed data tag and value to change a limit (e.g., No CVM limit, etc.). Other non-limiting aspects of commands that can be sent to the programmable component 103 via the wireless communications component 2008 can include, for example, SELECT (e.g., a command to select a card manager, security domain, and/or application, etc.), INITIALIZE UPDATE (e.g., to establish a secure channel with the card 100, etc.), EXTERNAL AUTHENTICATE (e.g., to authenticate and set the security level of the established, secure channel, etc.), LOAD (e.g., to send executable binary to the security domain, etc.), GET DATA (e.g., to retrieve data from the application and/or security domain, etc.), and/or INSTALL (e.g., to perform card content management, etc.), amongst others.

According to some non-limiting aspects, the programmable component 103 of the card 100 of FIG. 2 can be configured to generate a response, such as an APDU response, that is responsive to a received APDU command. As such, the generated response can be transmitted back to the portable electronic device 102 via the wireless communication component 2008. For example, according to some non-limiting aspects, responses that can be sent from the programmable component 103 via the wireless communications component 2008 can include, for example, File Control Information (“FCI”) (e.g., in response to a SELECT command, etc.), KDV, Info_{key}, Challenge_{card}, Cryptogram_{Card} (e.g., in response to an INITIALIZE UPDATE command, etc.), a 9000 response or 6300 response (e.g., in response to an EXTERNAL AUTHENTICATE command, etc.), Length, Load Confirmation, a 9000 response, a 6581 response, or a 6A84 response (e.g., in response to a LOAD command, etc.), a 9000 response, a 6A88 response, or a 6A84 response (e.g., in response to a STORE DATA command, etc.), TAG, Length, DATA, a 9000 response, a 6A80 response, or a 6A88 response (e.g., in response to a GET DATA command, etc.), and/or a 9000 response, a 6581 response, a 6A80 response, a 6A88 response, or a 6A84 response (e.g., in response to a INSTALL command, etc.), amongst others. Each command and response can be block oriented and transmissions via the wireless communication component 2008 can be performed in compliance with ISO 7816 Specification and/or various vendor extensions.

With reference to FIG. 2 together with FIGS. 1A, 1B, and 3, it shall be appreciated that the payment card 100 of FIG. 2 can be reconfigured wirelessly, without requiring an on-board battery or power source. As previously discussed, this can enable certain tokens and/or limits to be applied to the payment card 100, However, according to some non-limiting aspects, a single payment card 100 can be reconfigured to function with any number of accounts (e.g., a debit account, a credit account, a membership account, an identification credential, a health savings account, a loyalty rewards account, and/or a cryptocurrency account, etc.). The payment card 100, therefore, can promote tokenization, wherein account information (e.g., a primary account number (“PAN”), etc.) is replaced with a unique, randomly-generated sequence of numbers and thus, enhance security. The payment card 100 can also promote mobile use-cases via the application and/or API while preserving the use of a physical payment card 100, which many consumers may be more comfortable with. Moreover, according to some non-limiting aspects, the wireless charging component 2006 may only power the wireless communications component 2008 when the payment card 100 is inductively coupled with the charging coil 210 (FIG. 3) of the portable electronic device 102 (FIGS. 1A and 1B). As such, communications may only be sent to and from the payment card 100 when it is within a certain proximity of the portable electronic device 102, which can promote security and privacy.

Referring now to FIG. 3 together with FIGS. 1A, 1B, and 2, FIG. 3 depicts a simplified representation of a wireless charging system 200 including a portable electronic device 204 and a wireless charging device 202, in accordance with at least one non-limiting aspect of the present disclosure. It shall be appreciated that the portable electronic device 102 (FIGS. 1A and 1B)—or any other computing device, for that matter—can be configured similar to the portable electronic device 204 of the wireless charging system 200 (FIG. 3). According to other non-limiting aspects, a peripheral device configured for use with a portable electronic device and/or a computing device can be configured similar to the portable electronic device 204 of the wireless charging system 200. For example, it may be beneficial to use a peripheral device that includes the wireless charging system 200 to power the wireless charging component 2006 (FIG. 2) of the payment card 100 (FIG. 2), while a separate computing device transmits commands and responses to and from the wireless communications component 2008 (FIG. 2) of the payment card 100.

According to the non-limiting aspect of FIG. 3, the portable electronic device 204 can be positioned on a charging surface 208 of the wireless charging device 202. For example, the wireless charging device 202 can include any device that is configured to generate time-varying magnetic flux to induce a current in a suitably configured receiving device. The portable electronic device 204 can include a charging coil 210 and the wireless charging device 202 can include a charging coil 212 (e.g., inductive charging coils 210, 212), both of which can be configured to enable a wireless transfer of electrical power. For example, the charging coil 212 of the wireless charging device 202 can include a transmitter coil that generates a time-varying magnetic flux 214 and the charging coil 210 of the portable electronic device 204 can include a receiver coil in which an electric current is induced in response to the time-varying magnetic flux 214. It shall be appreciated that the electric current induced in the portable electronic device 204 receiver coil can be used to charge a battery or alternate power source, to provide operating power to a component of the portable electronic device 204, and/or for other purposes as desired.

With reference to FIG. 3 together with FIG. 3, it shall be appreciated that the charging enabled by the wireless charging system 200 (FIG. 3) can be configured to function in any direction. In the context of the portable electronic device 204, this means the portable electronic device 204 can further include a transmitter coil configured to induce a magnetic flux in a charging coil of another device, such as the payment card 100 (FIG. 2). Alternately and/or additionally, charging enabled by the wireless charging system 200 can be bidirectional. According to some non-limiting aspects, the portable electronic device 204 and/or the wireless charging device 202 can be configured for reverse wireless charging. For example, the charging coil 210 of the portable electronic device 204 can be configured to function as a receiving coil and a transmitting coil, such that the portable electronic device 204 can receive electrical power from the wireless charging device 202 and can transmit electrical power to the payment card 100.

With reference now to FIG. 3, as previously discussed, it may be desirable to align the charging coils 212, 210 of the wireless charging system 200 to promote an efficient transfer of wireless power from the wireless charging device 202 to the portable electronic device 204. As such, according to a non-limiting aspect, a magnetic alignment system 206 can provide such alignment. However, it shall be appreciated that, according to other non-limiting aspects, a desirable alignment can be alternately achieved via a sleeve, a case for the portable electronic device 204. Alternately and/or additionally, a desirable alignment of the charging coils 212, 210 can be manually achieved. Nonetheless, according to a non-limiting aspect, the magnetic alignment system 206 can include a ferromagnetic component 218 disposed within or on a surface of the portable electronic device 204 and a ferromagnetic component 216 disposed within or on a surface of the wireless charging device 202. The ferromagnetic components 216 and 218 can be configured to magnetically attract one another into an aligned position that causes the charging coils 210 and 212 to be aligned.

It shall be appreciated that the ferromagnetic component 216 and/or the ferromagnetic component 218 of the magnetic alignment system 206 can be formed of one or more magnets, such as arcuate magnets arranged in an annular configuration (e.g., an array of arcuate magnets arranged in an annular configuration). According to some non-limiting aspects, each of the arcuate magnets can have its magnetic polarity oriented in a desired direction so that magnetic attraction between the ferromagnetic component 216 and the ferromagnetic component 218 provides a desired alignment. In some aspects, the ferromagnetic component 216 and/or the ferromagnetic component 218 can include one or more than one magnet that includes a first magnetic region with a magnetic polarity oriented in a first direction and a second magnetic region with a magnetic polarity oriented in a second direction different from (e.g., opposite to) the first direction.

Referring now to FIG. 4 together with FIGS. 2 and 3, a portable electronic device 102 including a wireless charging system 110 is depicted in accordance with at least one aspect of the present disclosure. According to the non-limiting aspect of FIG. 4, the wireless charging system 110 can be encased within an outer housing of the portable electronic device 102 and therefore may not be visible when looking at the assembled portable electronic device 102. For illustrative purposes, FIG. 3 shows the position of the wireless charging system 110 within the portable electronic device 102. The wireless charging system 110 can include a charging coil 104 and a ferromagnetic component 106 disposed about the charging coil 104. The electronic device 102 can be similar in many respects to the portable electronic device 204 of FIG. 2. For example, the charging coil 104 can be similar to the charging coil 210 and the ferromagnetic component 106 can be similar to the ferromagnetic component 218. In some aspects, the wireless charging system 110 can further include a ferromagnetic alignment component 108 that is configured to rotationally align the portable electronic device 102 relative to a wireless charging device (e.g., after the charging coil 104 is concentrically aligned with a charging coil of the wireless charging device by the ferromagnetic component 106). For example, the ferromagnetic alignment component 108 may act to ensure that the elongated edges of the portable electronic device 102 are rotationally oriented in a desired position with respect to a wireless charging device.

Although FIG. 4 depicts the ferromagnetic alignment components 106, 108 in a specific configuration (e.g., a strip of ferromagnetic material disposed proximately to a ring of ferromagnetic material that surrounds the charging coil 104), the wireless charging system 110 can include various other configurations of the ferromagnetic alignment components 106, 108. For example, the ferromagnetic component 106 can include an array of multiple ferromagnetic components disposed about the charging coil 104, for example, in a linear configuration, a polygonal configuration (e.g., a polygon with 3, 4, 5, 6, 7, 8, or more than 8 sides), or a ring configuration. As another example, the ferromagnetic alignment component 108 may include an array of multiple ferromagnetic components positioned relative to the ferromagnetic component 106, for example, in a linear configuration, a polygonal configuration (e.g., a polygon with 3, 4, 5, 6, 7, 8, or more than 8 sides), or a ring configuration. As yet another example, the ferromagnetic alignment component 108 may be omitted from the wireless charging system 110.

Having described illustrative examples of various portable electronic devices, wireless charging systems, and ferromagnetic components included in the portable electronic devices and/or the wireless charging systems, the disclosure now turns to various payment cards that are removably attachable to portable electronic devices.

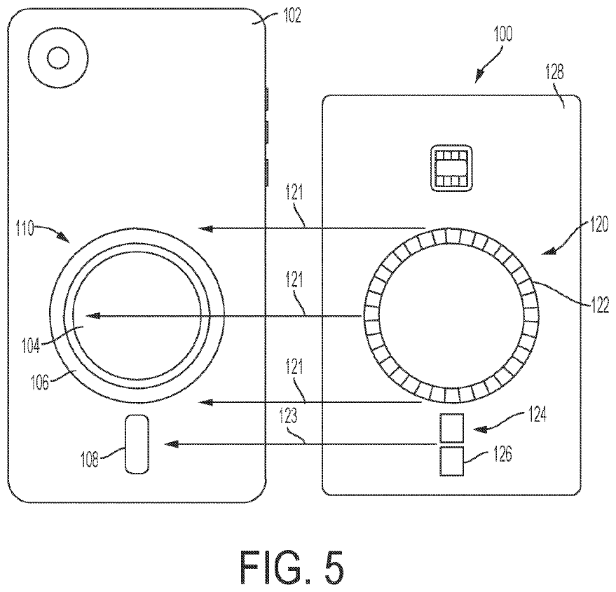

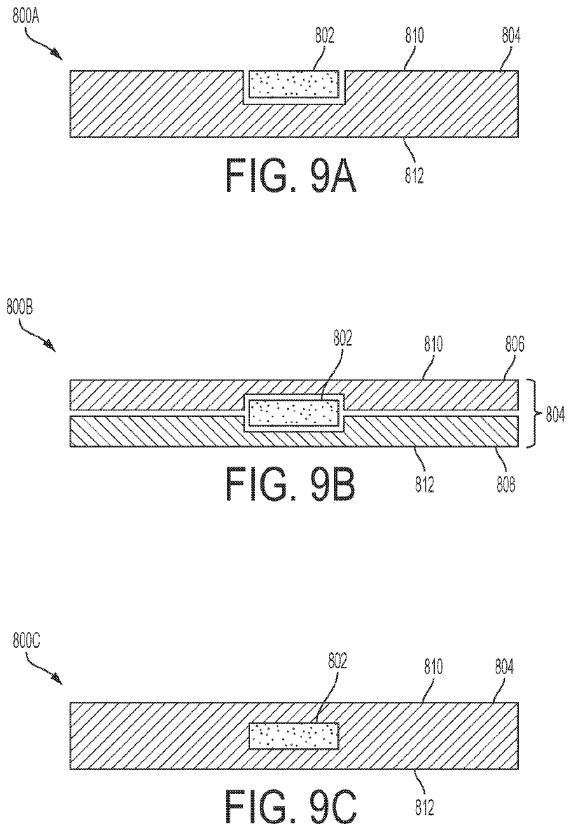

Referring now to FIG. 5, a payment card 100 configured for removable attachment to the portable electronic device 102 of FIG. 4 is depicted according to at least one aspect of the present disclosure. The payment card 100 can include a substrate 128 and a magnet 122 supported by and/or integrated within the substrate 128, as will be described in further detail with reference to FIGS. 9A and 9B. As previously described, the magnet 122 can be configured to magnetically couple with the ferromagnetic component 106 of the portable electronic device 102. According to the non-limiting aspect of FIG. 5, the payment card 100 can include multiple magnets 122 forming a magnet array 120 and defining a ring that complements the ring configuration of the ferromagnetic component 106. However, according to other aspects, the payment card 100 can include alternate magnet 122 and/or magnet array 120 configurations. For example, the payment card 100 can include any of the magnet and/or magnet array configurations described in detail below with respect to FIGS. 7A-7D, including a linear configuration, a polygonal configuration (e.g., a polygon with 3, 4, 5, 6, 7, 8, or more than 8 sides), a ring configuration, or any other suitable configuration that defines a profile that complements a ferromagnetic component included in a portable electronic device.

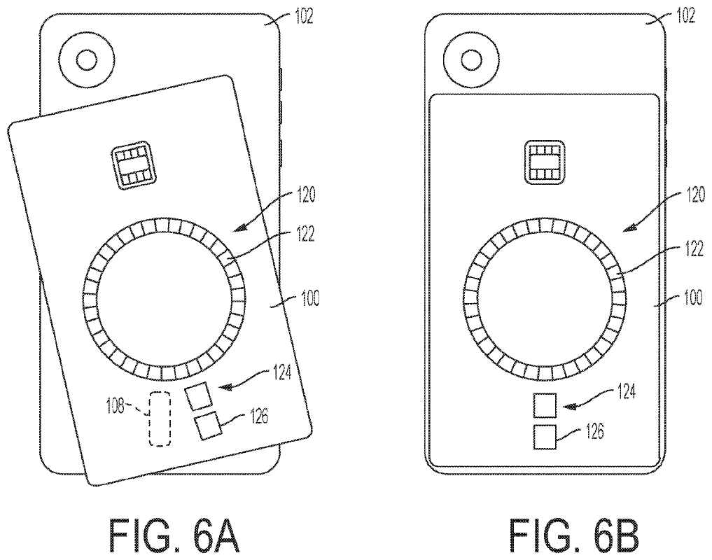

In further reference to the non-limiting aspect of FIG. 5, the payment card 100 can include an alignment component 126 supported by the substrate 128. Similar to the alignment component 2012 of FIG. 2, the alignment component 126 can be configured to ensure that the payment card 100 is not just removably attached to the portable electronic device 102, but properly aligned relative to the portable electronic device 102. For example, the alignment component 126 can include a magnet configured to magnetically couple to the ferromagnetic alignment component 108 of the portable electronic device 102 to align the payment card 100 relative to the portable electronic device 102, as will be described in further detail with reference to FIGS. 6A and 6B. According to the non-limiting aspect of FIG. 5, the payment card 100 can include several alignment components 126 arranged as an alignment array 124. In other aspects, the payment card 100 can include other alignment component 126 and/or alignment array 124 configurations. For example, the alignment component(s) 126 and/or the alignment array 124 can be configured to define a profile that complements any of the various ferromagnetic alignment component 108 configurations that may be used in the portable electronic device 102. Accordingly, the alignment magnet(s) 126 and/or the alignment magnet array 124 can define, for example, a linear configuration, a polygonal configuration (e.g., a polygon with 3, 4, 5, 6, 7, 8, or more than 8 sides), a ring configuration, or any other suitable configuration. However, according to other aspects, a single alignment component 126 may be implemented. According to still other aspects, the alignment magnet(s) 126 and/or the alignment magnet array 124 may be omitted from the payment card 100.

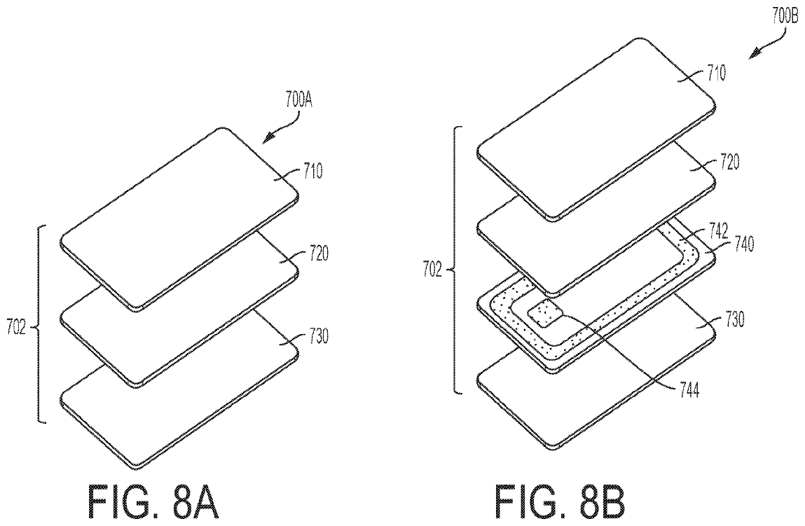

Still referring to FIG. 5, the substrate 128 can include any layer that forms part of the body of the payment card 100 (e.g., the card body) or the substrate 128 can include the entire card body of the payment card 100. For example, as described in detail below with respect to FIGS. 8A and 8B, the payment card 100 can include a laminate structure that utilizes several layers of material. Thus, in aspects where the payment card 100 includes multiple layers of material, the substrate 128 can include any one or more than one of the layers, such as, for example, all of the layers. In aspects where the payment card 100 includes only a single, integral material, the substrate can include the single material, itself. Several non-limiting examples of suitable materials for the substrate 128 and/or the layers thereof are described in further detail with reference to FIGS. 8A and 8B.

According to some non-limiting aspects, the magnet(s) 122 and/or the alignment magnet(s) 126 of FIG. 5 can be embedded within the substrate 128. For example, as described in detail below with respect to FIGS. 8A-8C, the substrate 128 can define a first surface and a second surface opposite the first surface. The payment card 100 can be configured such that neither the magnet(s) 122 nor the alignment magnet(s) 126 protrude beyond the first surface or the second surface of the substrate 128. According to one aspect, any of the magnet(s) 122 and/or the alignment magnet(s) 126 can be substantially flush with the first surface and/or the second surface of the substrate 128. Thus, the magnet(s) 122 and/or the alignment magnet(s) 126 may be visible when looking at the assembled payment card 100 (e.g., as shown in FIG. 4). However, according to other aspects, any of the magnet(s) 122 and/or the alignment magnet(s) 126 can be embedded between the first surface and the second surface (e.g., fully embedded within the substrate 128). Thus, the magnet(s) 122 and/or the alignment magnet(s) 126 may not be visible when looking at the assembled payment card 100.

It shall be appreciated that embedding the magnet(s) 122 and/or the alignment magnet(s) 126 in the substrate 128 of FIG. 5 can allow the payment card 100 to be inserted into an access device (e.g., swiped across a magnetic stripe reader, inserted into a chip reader, etc.). For example, inserting the payment card 100 into an access device may require that a first surface and a second surface (e.g., a front surface and a back surface) of the payment card 100 be substantially flat so that the payment card 100 can be smoothly swiped across or inserted into the access device. If the magnet(s) 122 and/or the alignment magnet(s) 126 protruded beyond the first surface and or the second surface of the payment card 100, then the magnet(s) 122 and/or the alignment magnet(s) 126 could contact the access device and potentially prevent the payment card 100 from being smoothly swiped or inserted therein. In some aspects, this may prevent the payment card 100 from being fully swiped or inserted and could ultimately prevent the access device from reading information stored on the payment card 100. Thus, embedding the magnet(s) 122 and/or the alignment magnet(s) 126 in the substrate 128 can allow the payment card 100 to be being fully swiped across or inserted into an access device without causing physical interference through contact.

According to the non-limiting aspect of FIG. 5, the magnet(s) 122 and/or the alignment magnet(s) 126 can enable the payment card 100 to be removably attached to and/or aligned with the portable electronic device 102 by magnetically coupling with components of the wireless charging system 110. For example, as indicated by the arrows 121, the magnets 122 of magnet array 120 can be arranged such that they magnetically couple with the ferromagnetic component 106 of the wireless charging system 110. Similarly, as indicated by the arrow 123, the alignment magnets 126 of the alignment magnet array 124 can magnetically couple with the ferromagnetic alignment component 108 of the wireless charging system 110. Thus, in some aspects, the payment card 100 can be configured to reliably attach to the portable electronic device 102 by taking advantage of various ferromagnetic components that are already included in the portable electronic device 102 as part of a wireless charging system 110.

Referring now to FIGS. 6A and 6B, an alignment of the payment card 100 of FIG. 5 relative to the portable electronic device 102 of FIG. 5 is depicted in accordance with at least one aspect of the present disclosure. For example, the alignment of FIGS. 6A and 6B can be based on a magnetic coupling of the alignment magnet(s) 126 to the ferromagnetic alignment component 108. As explained above, the magnets 122 of the magnet array 120 can magnetically couple with the ferromagnetic component 106 to removably attach the payment card 100 to the portable electronic device 102. According to some aspects, the payment card 100 may not be aligned relative to the portable electronic device 102 even after the magnets 122 of the magnet array 120 are magnetically coupled with the ferromagnetic component 106. For example, as shown in FIG. 5A, the magnets 122 of magnet array 120 are magnetically coupled with the ferromagnetic component 106 (not shown in FIG. 5A) but the various edges of the payment card 100 are not parallel with the various edges of the portable electronic device 102 and some corners of the payment card 100 are exposed. Thus, the payment card 100 is potentially susceptible to becoming inadvertently removed, for example, by an object contacting one of the exposed corners and/or surfaces of the payment card 100.

However, according to the non-limiting aspect of FIG. 6B, as the alignment component 126 of the alignment array 124 magnetically couples with the ferromagnetic alignment component 108 of the portable electronic device 102, the payment card 100 can be rotationally aligned with the portable electronic device 102. Assuming that—as depicted in FIGS. 6A and 6B—the portable electronic device 102 has a width and a length that is either equal to or exceeds a corresponding width and length of the payment card 100, this can result in the various edges of the payment card 100 to be parallel or substantially parallel with the various edges of the portable electronic device 102. A such, the corners and/or surfaces of the payment card 100 may not be exposed. In other words, as a result of the alignment caused by the alignment magnet(s) 126 magnetically coupling with the ferromagnetic alignment component 108, the payment card 100 may be less susceptible to becoming inadvertently removed from the payment card 102. Furthermore, the payment card 100 may be aesthetically positioned with respect to the portable electronic device 102.

Referring now to FIGS. 7A-7D, several payment cards 600, 610, 620, 630 including various magnet arrays are depicted in accordance with at least several non-limiting aspects of the present disclosure. It shall be appreciated that payment card 100 described above can be altered to include one or more of the features of any of the payment cards 600, 610, 620, 630 depicted in FIGS. 7A-7D. As noted above with respect to FIG. 5, the magnet(s) 122 and/or the magnet array 120 can define a linear configuration, a polygonal configuration (e.g., a polygon with 3, 4, 5, 6, 7, 8, or more than 8 sides), or a ring configuration. For example, FIG. 7A depicts a non-limiting aspect wherein a magnet array 602 includes magnets 604 arranged in a linear configuration. FIG. 7B depicts a non-limiting aspect wherein a magnet array 612 includes magnets 614 arranged in a ring configuration. FIG. 7C depicts a non-limiting aspect wherein a magnet array 622 includes magnets 624 arranged in a polygonal configuration. FIG. 7D depicts a non-limiting aspect wherein a magnet array 632 includes a single magnet 634. According to the non-limiting aspects of FIGS. 7A-7D, the magnets 604, 614, 624, 634 can be substantially flush with an outer surface of the respective payment card 600, 610, 620, 630. Alternatively and/or additionally, any one or more than one of the magnets 604, 614, 624, 634 can be wholly embedded in the respective payment card 600, 610, 620, 630.

The non-limiting aspects of FIGS. 7A-7D illustrate how varying numbers, shapes, and sizes of magnets can be arranged in a variety of magnet arrays. However, the specific configurations depicted in FIGS. 7A-7D are provided for illustrative purposes and thus should not be limited in this context. Similarly, the depictions of the position of the magnets 604, 614, 624, 634 within the payment cards 600, 610, 620, 630 and the position of the magnets 604, 614, 624, 634 relative to each other are provided for illustrative purposes. Accordingly, it shall be appreciated that the position of any of the magnet arrays 602, 612, 622, 632 can be shifted, rotated, and/or otherwise modified. Further, any of the magnet arrays disclosed herein (e.g., magnet arrays 602, 612, 622, 632) can include any number (any positive integer greater than or equal to one) of magnets. The magnets included in any a particular magnet array can all be the same size and shape or can have varying sizes and/or shapes. For example, the magnets included in a particular magnet array can have any combination of arcuate (e.g., arc-shaped, curve-shaped, similar to magnets 614 of FIG. 6B), square-shaped (e.g., similar to magnet 634 of FIG. 6D), rectangular-shaped (e.g., similar to magnets 604 of FIG. 6A), circle-shaped, ellipse-shaped, polygon-shaped, and/or other suitably shaped magnets. Further, the alignment magnet(s) and the alignment magnet arrays disclosed herein (e.g., alignment magnet(s) 126, alignment magnet array 124) can be configured similarly to any of the magnets and magnet arrays (e.g., magnets 604, 614, 624, 634, magnet arrays 602, 612, 622, 632) disclosed herein.

According to some non-limiting aspects, any magnets disclosed herein (e.g., the magnet(s) 122, the alignment magnet(s) 124, the magnets 604, 614, 624, 634) can be made of a magnetic material such as an neodymium-iron-boron (NdFeB), other rare earth magnetic materials, and/or any other materials (e.g., ferromagnetic materials) that can be magnetized to create a persistent magnetic field. In some aspects, any of the magnets disclosed herein can have a monolithic structure having a single magnetic region with a magnetic polarity aligned in a direction normal to a first surface and a second surface (e.g., a front and back surface) of the payment card (e.g., payment card 100, 600, 610, 620, 630).

For example, referring again to FIG. 5, in some aspects, each of the magnets 122 can include a bar magnet that has been ground and shaped into an arcuate structure. The substrate 128 can have a first surface and a second surface opposite the first surface (e.g., a surface facing towards the portable electronic device 102 and a surface facing away from the portable electronic device 102). Each of the magnets 122 may have a magnetic orientation that is normal to the first and second surfaces of the substrate 128. In one aspect, when the payment card 100 is attached to the portable electronic device 102, the magnets 122 may have a north pole oriented in a direction facing towards the portable electronic device 102 a south pole oriented in a direction facing away from the portable electronic device 102. In another aspect, when the payment card 100 is attached to the portable electronic device 102, the magnets 122 may have a north pole that is oriented in a direction facing away from the portable electronic device 102 and a south pole oriented in a direction facing towards the portable electronic device 102. As another example, rather than having multiple magnets 122, the magnet array 120 may be formed of a single, monolithic annular magnet 122.

Referring now to FIGS. 8A and 8B, several payment cards 700A, 700B having multiple layers are depicted in accordance with at least several non-limiting aspects of the present disclosure. Once again, it shall be appreciated that payment card 100 described above can be altered to include one or more of the features of the payment cards 700A, 700B depicted in FIGS. 8A and 8B. As noted above with respect to FIG. 5, the payment card 100 can be constructed using one or more than one layer of material. FIG. 8A illustrates a non-limiting aspect of a payment card 700A including a first layer 710, a second layer 720, and a third layer 730. Each of the layers 710, 720, 730 can be laminated and/or otherwise bonded together to form the card body 702. According to the non-limiting aspect of FIG. 7B, the payment card 700B can further include a fourth layer 740. Once again, each of the layers 710, 720, 730, 740 can be laminated and/or otherwise bonded together to form the card body 702. However, according to other non-limiting aspects, the payment cards 700A, 700B can have less than 3 layers (e.g., one layer or two layers) or more than four layers (e.g., five layers, six layers, seven layers, etc.).

Still referring to FIGS. 8A and 8B, according to some non-limiting aspects, the first layer 710 and the third layer 730 can include printed layers. For example, the first layer 710 may define a first surface (e.g., front surface) of the payment card 700A, 700B and can include a graphic and/or text that is printed, etched, embedded, or otherwise formed thereon. Likewise, the third layer 730 may define a second surface (e.g., back surface) that is opposite the first surface and can also include a graphic and/or text that is printed, etched, embedded, or otherwise formed thereon. The second layer 720 can include a core layer. For example the layer 720 can be configured to primarily provide structural support to the card body 702. Thus, according to some non-limiting aspects, the layer 720 may have a thickness that is relatively thicker than the layer 710 and/or the layer 730.

With specific reference to FIG. 7B, the fourth layer 740 can be configured to include any of the components described in reference to FIG. 2. According to the non-limiting aspect of FIG. 7B, the fourth layer 740 can include a near-field communications (“NFC”) antenna layer. An NFC antenna 742 can be embedded and/or otherwise integrated into the fourth layer 740. The NFC antenna 742 can be configured similar to the transaction antenna 2014 of the payment card 100, as described in reference to FIG. 2. According to some non-limiting aspects, an integrated chip 744 may be embedded or otherwise included in the layer 740. For example, the integrated chip 744 can include any of the wireless charging component 2006, the wireless communications component 2008, and/or the wireless antenna 2010 of the payment card 100 of FIG. 2. However, the integrated chip 744 can include any electronics necessary to facilitate the reconfiguration of a programmable component 103 (FIG. 2), as described herein. Generally, the NFC antenna 742 and/or the integrated chip 744 can be configured to transmit data (e.g., an account identifier, a name of an account holder, etc.) to an access device to initiate a transaction. However, according to other non-limiting aspects, the NFC antenna 724 and any other electronics required to reconfigure a programmable component 103, can be included in any of the layers 710, 720, 730, 740 of the payment cards 700A, 700B. For example, rather than having a separate NFC antenna layer (e.g., the fourth layer 740), the NFC antenna 724 and any other electronics required to reconfigure a programmable component 103, can be included in a core layer (e.g., the second layer 720 of payment card 700A, 700B). However, it shall be appreciated that the integrated chip 744 can be embedded or otherwise included in one or more than one alternate layers. For example, the integrated chip 744 may be included in or otherwise be supported by any one of the layers 710, 720, 730, or any combination of the layers 710, 720, 730.

According to some non-limiting aspects, the payment cards 700A, 700B of FIGS. 8A and 8B can include one or more transparent layers (not shown). For example, a transparent layer may be placed on an outer surface of the layer 710 and/or an outer surface of the layer 730. Thus, in some aspects, a first transparent layer may define a first surface (e.g., front surface) of the payment card 700A, 700B (and/or the card body 702) that protects a printed layer (e.g., the layer 710) while still allowing any graphics or text included in the printed layer to be visible. Likewise, in some aspects, a second transparent layer may define a second surface (e.g., back surface) of the payment card 700A, 700B (and/or the card body 702) that protects a printed layer (e.g., the layer 730) while still allowing any graphics or text included in the printed layer to be visible. The transparent layer(s) may include a transparent film made of, for example, polyvinyl chloride (PVC) or polyethylene terephthalate (PET). In some aspects, a magnetic stripe storing data (e.g., an account identifier, a name of an account holder, etc.) readable by an access device to initiate a transaction may be included on a transparent layer. In other aspects, a magnetic stripe storing data may be included on any one of the layers 710, 730, and/or another layer, or any combination of the layers, of the payment card 700A, 700B.

Any of the layers of the payment cards 700A, 700B of FIGS. 8A and 8B can be constructed using a polymeric material, a metallic material, a paper material, and/or a wood material. Examples of suitable polymeric materials may include polyvinyl chloride (“PVC”), polyvinyl chloride acetate (“PVCA”), polylactic acid (“PLA”), acrylonitrile butadiene styrene (“ABS”), polyethylene terephthalate (“PET”), polyester, polycarbonate, polyethylene terephthalate glycol (“PETG”), polyolefin, polycarbonate, polyester, polyamide, and copolymers and/or blends of any thereof. Examples of suitable metallic materials may include stainless steel, aluminum, tungsten, gold, titanium, copper, and alloys of any thereof. Any of the layers of the payment cards 700A, 700B may be bonded together using heat and/or an appropriate adhesive such as an epoxy-, polyurethane-, and/or acrylate-based adhesive.

Referring still to FIG. 8A and FIG. 8B, according to some non-limiting aspects, the mass of the card body 702 can be in a range of 3 g to 25 g, such as about 3 g, 4 g, 5 g, 6 g, 7 g, 8 g, 9 g, 10 g, 11 g, 12 g, 13 g, 14 g, 15 g, 16 g, 17 g, 18 g, 19 g, 20 g, 21 g, 22 g, 23g, 24 g, or about 25 g. In various aspects, the thickness of the card body 702 can be in a range of 0.50 mm to 1.00 mm, such as about 0.50 mm, 0.60 mm, 0.70 mm, 0.76 mm, 0.80 mm, 0.90 mm, or about 1.00 mm. In certain aspects, the mass and/or thickness of the card body 702 can be the standard mass and/or thickness for a payment card. For example, the card body 702 can be configured with a thickness required for the payment card 700A, 700B to be readily swiped or inserted into an access device without interference.

As mentioned above with respect to FIG. 5, the substrate 128 can refer to any layer that forms part of the body of the payment card 100 (e.g., the card body) or the entire body of the payment card 100. Thus, referring now to FIG. 4 and FIGS. 8A and 8B, the substrate 128 can be any one or more than one of the layers 710, 720, 730, and/or 740, such as, for example, all of the layers (e.g., the entire card body 702). Any of the magnets (e.g., magnets 122, 604, 614, 624, 634, 802) and alignment magnets (e.g., alignment magnets 126, 802) disclosed herein can be embedded in any one or more than one of the layers 710, 720, 730, 740.

Referring now to FIGS. 9A-9C, several cross-sectional views of several magnet embedding configurations 800A, 800B, 800C are depicted in accordance with several non-limiting aspects of the present disclosure. Each magnet embedding configuration 800A, 800B, 800C includes a magnet 802 embedded in a substrate 804. Each substrate 804 includes a first surface 810 and a second surface 812 opposite the first surface 810. Further, in each magnet embedding configuration 800A, 800B, 800C, the magnet 802 does not protrude beyond the first surface 810 or the second surface 812. In some aspects, the substrate 804 shown in any of FIGS. 9A-9C can represent the substrate 128 referenced above with respect to FIG. 5, any one or more than one of the layers 710, 720, 730, 740 referenced above with respect to FIGS. 8A and 8B, and/or the card body 702 referenced above with respect to FIGS. 8A and 8B. Thus, in some aspects, the substrate 804 may be comprised of one or more than one layer. The magnet 802 shown in any of FIGS. 9A-9C can represent any one of the magnets (e.g., magnets 122, 604, 614, 624, 634) and/or the alignment magnets (e.g., alignment magnets 126) disclosed herein.

Referring now to FIG. 9A, the magnet embedding configuration 800A includes a magnet 802 implanted into the substrate 804 such that the magnet 802 is substantially flush with the first surface 810. In one aspect, the substrate 804 of the magnet embedding configuration 800A can represent a card body of a payment card (e.g., the card body 702 of FIGS. 8A and/or 8B) where any individual layers included in the card body are not shown in FIG. 9A. In this aspect, the first surface 810 and the second surface 812 of the substrate 804 may represent outer surfaces of a payment card. In another aspect, the substrate 804 of the magnet embedding configuration 800A can represent one layer of a payment card (e.g., one of the layers 710, 720, 730, 740 of FIGS. 8A and/or 8B). Accordingly, the first surface 810 and the second surface 812 of the substrate 804 may represent outer surfaces of a single layer of a payment card. The magnet 802 of the magnet embedding configuration 800A may be implanted into the substrate 804 by subtractively removing a portion of the substrate 804 to create a cavity and depositing the magnet 802 in the cavity. Subtractively removing the portion of the substrate 804 to create the cavity can include at least one of drilling, milling, laser cutting, etching, or machining the portion of the substrate 804.

Referring now to FIG. 9B, the magnet embedding configuration 800B includes a magnet 802 implanted into the substrate 804 such that the magnet is completely embedded in the substrate 804. Further, the substrate 804 of the magnet embedding configuration 800B includes a first layer 806 and a second layer 808. Each of the first layer 806 and the second layer 808 can represent one or more than one layer of a card body of a payment card (e.g., one or more than one of the layers 710, 720, 730, 740 of the card body 702 of FIGS. 8A and/or 8B). For example, referring to FIGS. 8B and 9B, the first layer 806 may represent the layer 720 of payment card 700B and the second layer 808 may represent the layer 740 of the payment card 700B. As another example, still referring to FIGS. 8B and 9B, the first layer 806 may represent the layers 710 and 720 of payment card 700B and the second layer 808 may represent the layers 740 and 730 of the payment card 700B such that the substrate 804 represents the entire card body 702 of payment card 700B. Referring again to FIG. 9B, the magnet 802 of the magnet embedding configuration 800B may be implanted into the substrate 804 by subtractively removing a portion of the first layer 806 to create a first cavity, subtractively removing a portion of the second layer 808 to create a second cavity, depositing the magnet 802 into at least one of the first cavity or the second cavity, and placing the first layer 806 and the second layer 808 together such that the magnet 802 spans the first cavity and the second cavity. Subtractively removing the portion of the first layer 806 to create the first cavity and/or subtractively removing the portion of the second layer 808 to create the second cavity can include at least one of drilling, milling, laser cutting, etching, or machining the portion of the first layer 806 and/or the portion of the second layer 808.

Referring now to FIG. 9C, the magnet embedding configuration 800C includes a magnet 802 that is molded (e.g., co-molded, insert molded) into the substrate 804. In one aspect, the substrate 804 of the magnet embedding configuration 800C can represent one layer of a payment card (e.g., one of the layers 710, 720, 730, or 740 of FIGS. 8A and/or 8B). Accordingly, the first surface 810 and the second surface 812 of substrate 804 may represent outer surfaces of a single layer of a payment card. In another aspect, the substrate 804 of the magnet embedding configuration 800C can represent a card body of a payment card. The magnet 802 of the magnet embedding configuration 800C may be molded into the substrate 804 by placing the magnet 802 into a cavity of a mold and injecting substrate material into the mold and around the magnet 802. In aspects where the substrate material is a polymer material (e.g., a thermoplastic material), molding the magnet 802 can further include curing the substrate material to form the substrate 804 (e.g., to form a layer of a payment card, to form a card body of a payment card). In aspects where the substrate material is a metallic material (e.g., a liquid metallic material, powdered metallic material), molding the magnet 802 can further include hardening (e.g., cooling, sintering) the substrate material to form the substrate 804 (e.g., to form a layer of a payment card, to form a card body of a payment card). In the magnet embedding configuration 800C depicted in FIG. 9C, the magnet 802 is fully embedded in the substrate 804. In other aspects, the magnet 802 of the magnet embedding configuration 800C may be substantially flush with the first surface 810 of the substrate 804 (e.g., similar to the magnet 802 of the magnet embedding configuration 800A depicted in FIG. 9A).

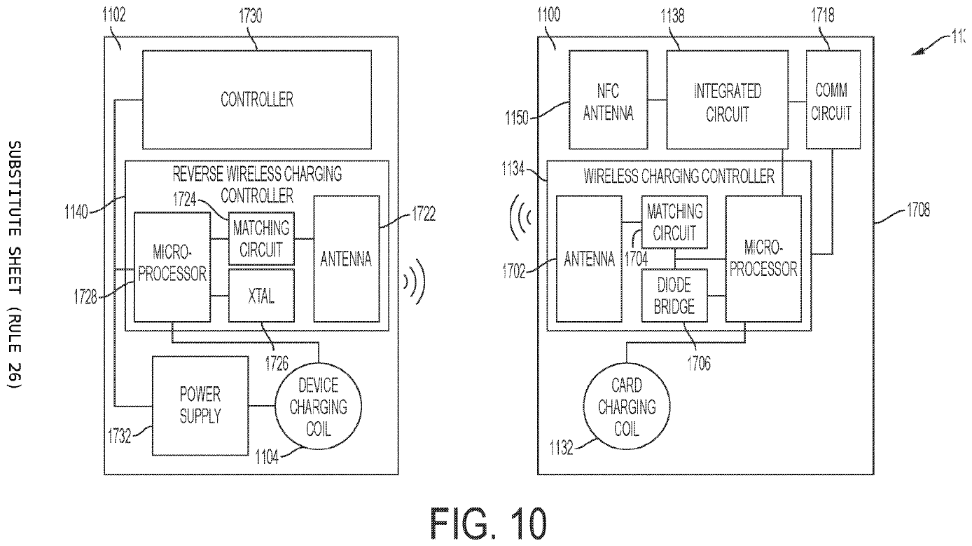

Referring now to FIG. 10, a simplified block circuit diagram of a card 1100 and a portable electronic device 1102 is depicted according to at least one aspect of the present disclosure. Although specific controller and/or microprocessor configurations are shown in FIG. 10, the various controllers and microprocessors described herein may be implemented as a control circuit, control logic, a microprocessor, a microcontroller, logic, a LSI (large-scale integration) circuit, or a FPGA (field-programmable gate array), or various combinations thereof. According to the non-limiting aspect of FIG. 10, the portable electronic device 1102 can include a controller 1730, a reverse wireless charging controller 1140, a power supply 1732, and a device charging coil 1104. The controller 1730 can be configured to control the main functions of the portable electronic device 1102 (e.g., portable electronic device 102 may be a smart phone and the controller 1730 may be the smart phone's central processing unit). The power supply 1732 can store energy to power to the portable electronic device 1102. For example, the power supply 1732 can include a battery that is chargeable via wireless charging using the device charging coil 1104. The reverse wireless charging controller 1140 can include a microprocessor 1728 and an antenna 1722 (e.g., an NFC antenna). Further, the reverse wireless charging controller 1140 can be configured to control power transfer from the power supply 1732 to the card 1100 via the device charging coil 1104. In some aspects, a reverse wireless charging controller 1140 can be implemented, including a crystal 1726 (xtal) (e.g., a 27.12 MHz crystal oscillator) and a matching circuit 1724. In some aspects, the reverse wireless charging controller 1140 may be similar to the 13.57 MHz Wireless Charger Module produced by RHOM Co., Ltd. (e.g., Part Number BP3621).

Additionally, as shown in FIG. 10, the circuit 1130 can include a wireless communications circuit 1718, an integrated circuit 1138 and a wireless charging controller 1134 that is separate from the integrated circuit 1138. In other aspects, the wireless communications circuit 1718, the wireless charging controller 1134, and the integrated circuit 1138 can be included together as part of a single integrated circuit. In yet other aspects, the card 1100 may not include the integrated circuit 138. The wireless communications circuit 1718, for example, can be configured similar to the wireless communications circuit 2008 of FIG. 2. Notably, electrical power drawn from the portable electronic device 102 can be used to power the wireless communications component 2008. In other words, the wireless communications component 1718 of the payment card 1100 of FIG. 10 can be configured to establish a low-power, low-data network, including NFC, Bluetooth® low-energy (“BLE”). Zigbee, Z-Wave, and/or 6LoWPAN, amongst others. The wireless communications component 1718 of the payment card 1100 can be communicably coupled with an application and/or application program interface (“API”) executed and/or otherwise accessed by the portable electronic device 1102.

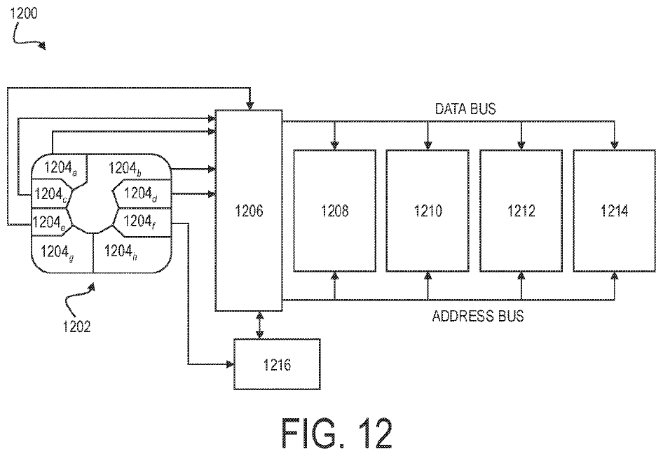

The integrated circuit 1138 of the card 1100 of FIG. 10 can include a programmable component configured to communicate with an access device (e.g., POS device 1304 of FIG. 11) to conduct a transaction. For example, the integrated circuit 1138 can include an EMV chip, such as the EMV chip 1400 of FIG. 12, which can be configured according to an ISO/IEC (International Organization for Standardization/International Electrotechnical Commission) 7816 and/or an ISO/IEC14443 standard. The NFC antenna 1150 can be electrically coupled to the integrated circuit 1138 and can be configured to enable wireless communication between the integrated circuit and an access device (e.g., POS device 1304 of FIG. 11). Thus, in some aspects, the card 1100 can be configured as a contact card and/or a contactless card.

According to the non-limiting aspect of FIG. 10, the wireless charging controller 134 can further include a microprocessor 1708 and an antenna 1702 (e.g., an NFC antenna) to enable wireless communication with the antenna 1722 of reverse wireless charging controller 1140. In some aspects the wireless charging controller 1134 can further include a diode bridge 1706 and a matching circuit 1704. In some aspects, the wireless charging controller 1134 may be similar to the 13.57 MHz Wireless Charger Module produced by RHOM Co., Ltd. (Part Number BP3622). The wireless charging controller 1134 can be configured to communicate with the reverse wireless charging controller 1140 to supply. For example, the wireless charging controller 1134 and the reverse wireless charging controller 1140 can determine when the card 1100 is attached to the portable electronic device 1102 based on communication via the antennas 1702, 1722. Upon detecting that the card 1100 is attached to the portable electronic device 1102, the wireless charging controller 1134 and/or the reverse wireless charging controller 1140 can cause the portable electronic device 1102 to generate magnetic flux via the device charging coil 1104. The magnetic flux generated by the device charging coil 1104 can induce a current in the card charging coil 1132 which can be used to power the wireless communication circuit 1718. Referring now to FIG. 11, a diagram of an example payment network environment 1300 in which a reconfigurable card, such as the cards 100, 1100 of FIGS. 1A, 1B, and 10, may be used to conduct a transaction is depicted in accordance with at least one non-limiting aspect of the present disclosure. As shown in FIG. 11, the payment network environment 1300 can include a payment gateway system 1302, a POS device 1304, a portable electronic device 102, a card 100, an issuer system 1308, a transaction service provider system 1310, an acquirer system 1312, and a communication network 1314. The payment gateway system 1302, the POS device 1304, the vicinity use card 100, the issuer system 1308, the transaction service provider system 1310, and/or the acquirer system 1312 may interconnect (e.g., establish a connection to communicate) via wired connections, wireless connections, or a combination of wired and wireless connections.

In further reference to FIG. 11, the payment gateway system 1302 can include one or more devices capable of receiving information from and/or transmitting information to a POS device 1304, the portable electronic device 102, the vicinity use card 100, the issuer system 1308, the transaction service provider system 1310, and/or the acquirer system 1312 via the communication network 1314. For example, the payment gateway system 1302 may include a computing device, such as a server (e.g., a transaction processing server), a group of servers, and/or other like devices.

The POS device 1304 of the payment network 1300 of FIG. 11 may include one or more devices capable of receiving information from and/or transmitting information to the payment gateway system 1302, the portable electronic device 102, the vicinity use card 100, the issuer system 1308, the transaction service provider system 1310, and/or the acquirer system 1312 via the communication network 1314. For example, the POS device 1304 may include a computing device and/or other like devices. The POS device 1304 may also include a device capable of receiving information from vicinity use card 100 via a communication connection (e.g., an NFC communication connection, an RFID communication connection, a Bluetooth® communication connection, and/or the like) with vicinity use card 100, and/or the like, and/or transmitting information to vicinity use card 100 via the communication connection, and/or the like. In some non-limiting embodiments, the POS device 1304 may be a component of a merchant system associated with a merchant, as described herein. In some aspects, the POS device 1304 may include one or more devices, such as computers, computer systems, and/or peripheral devices capable of being used by a merchant to conduct a payment transaction with a user using the vicinity use card 100. For example, POS device 1304 may include a POS terminal.

According to the non-limiting aspect of FIG. 11, the issuer system 1308 can include one or more devices capable of receiving information from and/or transmitting information to payment gateway system 1302, the POS device 1304, the portable electronic device 102, the vicinity use card 100, transaction service provider system 1310, and/or the acquirer system 1312 via the communication network 1314. For example, issuer system 1308 may include a computing device, such as a server, a group of servers, and/or other like devices. In various aspects, the issuer system 1308 may be associated with an issuer institution. For example, the issuer system 1308 may be associated with an issuer institution that issued a credit account, debit account, credit card account, debit card account, and/or the like to a user associated with the vicinity use card 100.

Still referring to the non-limiting aspect of FIG. 11, the transaction service provider system 1310 may include one or more devices capable of receiving information from and/or transmitting information to the payment gateway system 1302, the POS device 1304, the portable electronic device 102, the vicinity use card 100, the issuer system 1308, and/or the acquirer system 1312 via the communication network 1314. For example, the transaction service provider system 1310 may include a computing device, such as a server (e.g., a transaction processing server), a group of servers, and/or other like devices. In some aspects, the transaction service provider system 1310 may be associated with a transaction service provider. In some aspects, transaction service provider system 1310 may be in communication with a data storage device, which may be local or remote to the transaction service provider system 1310. In some aspects, the transaction service provider system 1310 may be capable of receiving information from, storing information in, transmitting information to, or searching information stored in a data storage device.

The acquirer system 1312 of the payment network 1300 of FIG. 11 may include one or more devices capable of receiving information from and/or transmitting information to the payment gateway system 1302, the POS device 1304, the portable electronic device 102, the vicinity use card 100, the issuer system 1308, and/or the transaction service provider system 1310 via the communication network 1314. For example, the acquirer system 1312 may include a computing device, such as a server, a group of servers, and/or other like devices. In some aspects, acquirer system 1312 may be associated with an acquirer. In some aspects, the acquirer system 1312 may be associated with a merchant account of a merchant associated with the POS device 1304.

In further reference to FIG. 11, the communication network 1314 can include one or more wired and/or wireless networks. For example, the communication network 1314 may include a cellular network (e.g., a long-term evolution (LTE) network, a fourth generation (4G), a fifth generation (5G) network, network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 11 are provided as an example. There may be additional devices and/or networks, fewer devices and/or networks, different devices and/or networks, or differently arranged devices and/or networks than those shown in FIG. 11. Furthermore, two or more devices shown in FIG. 11 may be implemented within a single device, or a single device shown in FIG. 11 may be implemented as multiple, distributed devices. Additionally or alternatively, a set of devices (e.g., one or more devices) of the payment network environment 1300 may perform one or more functions described as being performed by another set of devices of the payment network environment 1300.

Referring now to FIG. 12, a high-level circuit schematic of a programmable component 1200 configured for use with a reconfigurable payment card is depicted in accordance with at least one non-limiting aspect of the present disclosure. It shall be appreciated that a programmable component of any of the cards 100, 1100 disclosed herein can be configured as depicted in FIG. 12. According to the non-limiting aspect of FIG. 12 the programmable component 1200 can include an EMV circuit 1202, a processor 1206, an EEPROM 1208, a ROM 1210, a RAM 1212, and/or an encryption coprocessor 1214. The programmable component 1200 can further include an input/output circuit 1216. Notably, the EEPROM 1208 or another reconfigurable aspect of the programmable component 1200, such as a flash-based component, can be configured to be reprogrammed in response to a configuration update received from a computing device via a wireless communication component.

It shall be appreciated that the high-level circuit schematic of FIG. 12 depicts the processor 1206, the EEPROM 1208, the ROM 1210, the RAM 1212, the encryption coprocessor 1214, and the input/output circuit 1216 as separate components for illustrative purposes only and that, according to some non-limiting aspects, the processor 1206, the EEPROM 1208, the ROM 1210, the RAM 1212, and the encryption coprocessor 1214 are not separable components and are integrated into the structure of the EMV circuit 1202, itself. One or more of the components 1202, 1206, 1208, 1210, 1212, 1214 of the programmable component 1200 of FIG. 12 can be configured in accordance with one or more international standards, including ISO7810 and/or IS7816, amongst others, or one or more standards or extensions (e.g., the European telecommunications Standard Institue's (“ETSI”) Global System for Mobile Communications (“GSM”) standards, EMV, etc.). For example, according to some non-limiting aspects, the programmable component 1200 of FIG. 12 can include a 32 KB ROM 1210, a 32 KB EEPROM 1208, a 1-4 KB RAM 1212, and/or an 8 or 16 bit microprocessor 1206 with an external clock of 1-5 MHz.

According to the non-limiting aspect of FIG. 12, the EMV circuit 1202 can be configured as a smart card module. For example, according to some non-limiting aspects, the EMV circuit 1202 can be configured in accordance with ISO 7816-2 and may include various function-dedicated components, such as a power supply voltage component 1204ₐ, a ground component 1204_{b}, a reset component 1204_{c}, a programming voltage component 1204_{d}, a clock component 1204ₑ, an input/output component 1204_{f}, and/or one or more components reserved for future use 1204_{g}, 1204ₕ, amongst others. However, according to other non-limiting aspects, the programmable component 1200 can include another smart card module.

In further reference to FIG. 12, it shall be appreciated that the EEPROM 1208, the ROM 1210, and/or the RAM 1212 can be configured to store instructions to be executed by the processor 1206 and/or the encryption coprocessor 1214, to perform functions via any of the components 1204ₐ₋ₕ, of the EMV circuit 1202. Communications can be conveyed between the various components 1202, 1206, 1208, 1210, 1212, 1214 of the programmable component 1200 via a data bus, an address bus, and/or an input/output circuit 1216 of the programmable component 1200. For example, the ROM 1210 may store an operating system for the programmable component 1200 and the RAM 1212 may be used to carry out operations. The EEPROM 1208 may store application data and/or operating system extensions. The encryption coprocessor 1214 can support encryption/decryption computations and increase the communication security level of the programmable component 1200. The input/output circuit 1216 may further be communicably coupled to a wireless communications component of the card, such as the wireless communications component 2008 of FIG. 2 or the wireless communications component 1718 of FIG. 10. Accordingly, as the wireless communications component receives a configuration update from the computing device (e.g., personal electronic device 102 of FIG. 2), the configuration update may alter data stored in the EEPROM 1208. As such, the configuration update can cause the processor 1206 and/or the encryption coprocessor 1214 to change the functions performed via any of the components 1204ₐ₋ₕ, of the EMV circuit 1202 and therefore, reconfigure the programmable component 1200.

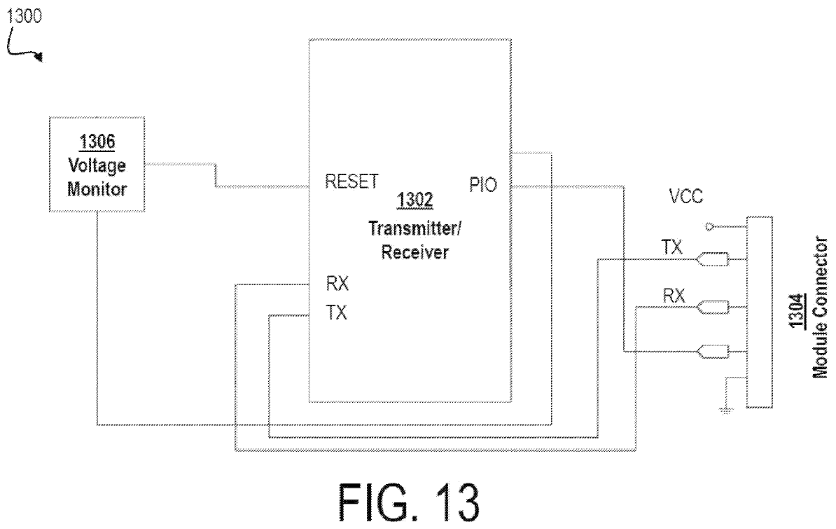

Referring now to FIG. 13, a circuit schematic of a wireless communications component 1300 is depicted in accordance with at least one non-limiting aspect of the present disclosure. It shall be appreciated that any of the wireless communications components 2008, 1718 disclosed herein can be configured as depicted in FIG. 13. In one aspect, the wireless communications component 1300 of FIG. 13 may be configured for Bluetooth® communications, and according to other non-limiting aspects, the wireless communications component 1300 can be alternately configured for communications via any number of wireless protocols, including NFC, Zigbee, Z-Wave, and/or 6LoWPAN, amongst others.

According to the non-limiting aspect of FIG. 13, the circuit 1300 can include a transmitter and receiver 1302, a module connector 1304, and a voltage monitor 1306. Specifically, the wireless communications component 1300 can establish low-power communications with a computing device, such as the personal electronic devices 102, 1102 of FIGS. 1A, 1B, and 10, via a high-output antenna. As such, the wireless communications component 1300 can establish ad hoc connections capable of communicating with a transmission power of up to +8 dBm and receiver sensibility of down to −83 dBm combined with low power consumption.

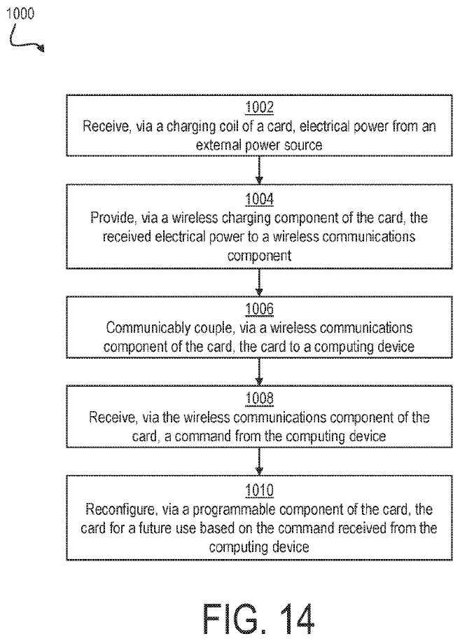

Referring now to FIG. 14, a logic flow diagram of a method 1000 of wirelessly reconfiguring a payment card is depicted in accordance with at least one non-limiting aspect of the present disclosure. According to the non-limiting aspect of FIG. 10 together with FIGS. 2 and 3, the method 1000 can be performed by a card, such as the payment card 100 of FIGS. 1A and 1B or the payment card 1100 of FIG. 10, via charging coil, such as the charging coil 2002 of FIG. 2, a wireless communication component, such as the circuits 2008, 1718, 1300 of FIGS. 2, 10, and 13, and a programmable component, such as the programmable components 1202, 1206, 1208, 1210, 1212, 1214 of FIG. 12, along with any other components of any of the payment cards disclosed herein. Additionally, it shall be appreciated that, according to other non-limiting aspects, the method 1000 of FIG. 10 can be performed by any card (e.g., a debit card, a credit card, a membership card, an identification card, a health savings account card, a loyalty rewards card, and/or a cryptocurrency card, etc.). According to the method 1000, a charging coil 2002 (FIG. 2) of a card 100 (FIGS. 1A and 1B) receives 1002 electrical power from an external power source. For example, electrical power can be wirelessly received from a portable electronic device 204 (FIG. 3) when a charging coil 2002 of the payment card 100 is inductively coupled to a charging coil 210 (FIG. 3) of a portable electronic device 204.

According to the non-limiting aspect of the method 1000, the wireless charging component 2006 (FIG. 2) of a card 100 (FIGS. 1A and 1B) provides 1004 the received electrical power to a wireless communications component 2008 (FIG. 2). As previously described and with reference now to FIG. 10 together with FIGS. 2 and 3, the wireless communications component 2008 can be configured to establish a low-power, low-data network, including NFC, Bluetooth® low-energy (“BLE”), Zigbee, Z-Wave, and/or 6LoWPAN, amongst others. As such, the wireless communications component 2008 (FIG. 2) communicably couples 1006 the payment card 100 (FIGS. 1A and 1B) to a computing device, such as a portable electronic device 204 (FIG. 3). According to some non-limiting aspects, communicably coupling 1006 the payment card 100 can be initiated or enabled via an application and/or API executed or otherwise accessed by the portable electronic device 204.

With continued reference to FIG. 14, together with FIGS. 2 and 3, once the payment card 100 (FIG. 2) is communicably coupled to the portable electronic device 204 (FIG. 3), according to the method 1000, the wireless communications component 2008 (FIG. 2) receives 1008 a communication from the computing device, such as the portable electronic device 204. For example, according to some non-limiting aspects, the communication can be transmitted via a command/response protocol, such as an APDU, and can include a command that is wrapped in a data packet. As previously discussed, the command can be configured for processing via a programmable component 103 (FIG. 2) of the payment card 100 and can invoke functions executed by the payment card 100. Once again, the payment card 100 can receive one or more configuration updates from the portable electronic device 204, wherein the configuration update causes the programmable component 103—and thus, the payment card 100, itself—to function in a particular manner. Accordingly, the method 1000 can further include reconfiguring the programmable component 103 of the payment card 100 based on the communication received from the computing device, or portable electronic device 204. For example, the communication can include a command to store, alter, and/or remove data from the programmable component 103 of the payment card 100.

With continued reference to FIG. 14 together with FIGS. 2 and 3, according to the method 1000, the programmable component 103 can reconfigure 1010 a payment card 100 (FIG. 2). In one aspect, the payment card 100 may be wirelessly reconfigured 1010 by the programmable component 103 without requiring the payment card 100 to have an on-board battery or power source. Specifically, this is due to the receipt of electrical power from an external power source, such as the portable electronic device 204 (FIG. 3) and the provision of received electrical power to a wireless communications component 2008 (FIG. 2) of the payment card 100. Thus, the method 1000 can enable certain tokens and/or limits to be applied to the payment card 100. According to some non-limiting aspects, the method 1000 can enable a single payment card 100 to be reconfigured to function with any number of accounts (e.g. a debit account, a credit account, a membership account, an identification credential, a health savings account, a loyalty rewards account, and/or a cryptocurrency account, etc.). As such, the method 1000 of FIG. 10 can provide a more efficient and less expensive means of wirelessly reconfiguring a payment card 100.

Examples of the devices, systems, and methods according to various aspects of the present disclosure are provided below in the following numbered clauses. An aspect of any of the devices(s), method(s) and/or system(s) may include any one or more than one, and any combination of, the numbered clauses described below.

Clause 1. A payment card, the payment card including a charging coil configured to generate electrical energy in response to a magnetic field generated by a corresponding charging coil of a computing device, and a wireless communication component electrically coupled to the charging coil, wherein the charging coil is configured to power the wireless communication circuit to communicate with the computing device via a wireless communication protocol.

Clause 2. The payment card according to clause 1, further including a programmable component, wherein the charging coil is configured to power the wireless communication circuit to receive a configuration update from the computing device via a wireless communication protocol, and wherein the programmable component is reconfigurable in accordance with the configuration update.

Clause 3. The payment card according to either of clauses 1 or 2, wherein the configuration update includes an Application Protocol Data Unit (“APDU”) command.

Clause 4. The payment card according to any of clauses 1-3, wherein the programmable component is further configured to generate an APDU response configured to respond to the APDU command, and wherein the wireless communication component is configured to transmit the generated APDU response to the computing device via the wireless communication protocol.

Clause 5. The payment card according to any of clauses 1-4, wherein the computing device includes a portable electronic device configured for reverse wireless charging.

Clause 6. The payment card according to any of clauses 1-5, wherein the charging coil of the payment card is further configured to be inductively coupled to the corresponding charging coil of the computing device when the charging coil of the payment card is aligned with the corresponding charging coil of the computing device.

Clause 7. The payment card according to any of clauses 1-6, wherein an alignment component is configured to align the charging coil of the payment card and the corresponding charging coil of the computing device.

Clause 8. The payment card according to any of clauses 1-7, wherein the alignment component includes a ferromagnetic component.

Clause 9. The payment card according to any of clauses 1-8, wherein the alignment component includes a sleeve configured to be adhesively attached to the computing device.

Clause 10. The payment card according to any of clauses 1-9, wherein the alignment component includes a case configured to protect the computing device.

Clause 11. The payment card according to any of clauses 1-10, further including a wireless charging component configured to regulate electrical energy generated by the charging coil of the payment card.

Clause 12. The payment card according to any of clauses 1-11, wherein the wireless communication protocol is a Bluetooth low-energy protocol.

Clause 13. A method of wirelessly reconfiguring a payment card, the method including aligning, via an alignment component of the payment card, a charging coil of the payment card with a corresponding charging coil of an external power source, receiving, via the charging coil of the payment card, electrical energy from the corresponding charging coil of the external power source, providing, via a wireless charging component of the payment card, the received electrical energy to a wireless communications component of the payment card, coupling the wireless communications component of the payment card to a computing device, receiving, via the wireless communications component of the payment card, a communication from the computing device, and reconfiguring, via a programmable component of the payment card, the payment card based on the received communication from the computing device.

Clause 14. The method according to clause 13, wherein the alignment component includes at least one of a ferromagnetic component, a sleeve configured to be adhesively attached to the computing device, and a case configured to protect the computing device, or combinations thereof.

Clause 15. The method according to either of clauses 13 or 14, wherein the communication includes an Application Protocol Data Unit (“APDU”) command.

Clause 16. The method according to either of clauses 13-15, further including generating, via the programmable component of the payment card, an APDU response configured to respond to the APDU command, and transmitting, via the wireless communications component of the payment card, the generated APDU response to the computing device.

Clause 17. A system, the system including a computing device including a processor and a memory configured to store an application that, when executed by the processor, causes the computing device to detect an available configuration update, and a payment card, wherein the payment card includes a charging coil configured to generate electrical energy in response to a magnetic field generated by the computing device, a wireless communication circuit electrically coupled to the charging coil, wherein the charging coil is configured to power the wireless communication circuit to receive the detected configuration update from the computing device via a wireless communication protocol, and a programmable component reconfigurable by the configuration update.

Clause 18. The system according to clause 17, wherein the payment card further includes an alignment component configured to align the charging coil of the payment card with a corresponding charging coil of the computing device.

Clause 19. The system according to either of clauses 17 or 18, wherein the alignment component includes at least one of a ferromagnetic component, a sleeve configured to be adhesively attached to the computing device, and a case configured to protect the computing device, or combinations thereof.

Clause 20. The system according to either of clauses 17-19, wherein the configuration update includes an Application Protocol Data Unit (“APDU”) command.

Further, it is understood that any one or more of the following-described forms, expressions of forms, examples, can be combined with any one or more of the other following-described forms, expressions of forms, and examples.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

The term “substantially”, “about”, or “approximately” as used in the present disclosure, unless otherwise specified, means an acceptable error for a particular value as determined by one of ordinary skill in the art, which depends in part on how the value is measured or determined. In certain aspects, the term “substantially”, “about”, or “approximately” means within 1, 2, 3, or 4 standard deviations. In certain aspects, the term “substantially”, “about”, or “approximately” means within 50%, 20%, 15%, 10%, 9%, 8%, 7%, 6%, 5%, 4%, 3%, 2%, 1%, 0.5%, or 0.05% of a given value or range.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

1. A payment card, the payment card comprising:
a charging coil configured to generate electrical energy in response to a magnetic field generated by a corresponding charging coil of a computing device; and
a wireless communication component electrically coupled to the charging coil, wherein the charging coil is configured to power the wireless communication circuit to communicate with the computing device via a wireless communication protocol.

2. The payment card of claim 1, further comprising a programmable component, wherein the charging coil is configured to power the wireless communication circuit to receive a configuration update from the computing device via a wireless communication protocol, and wherein the programmable component is reconfigurable in accordance with the configuration update.

3. The payment card of claim 1, wherein the configuration update comprises an Application Protocol Data Unit (“APDU”) command.

4. The payment card of claim 3, wherein the programmable component is further configured to generate an APDU response configured to respond to the APDU command, and wherein the wireless communication component is configured to transmit the generated APDU response to the computing device via the wireless communication protocol.

5. The payment card of claim 1, wherein the computing device comprises a portable electronic device configured for reverse wireless charging.

6. The payment card of claim 1, wherein the charging coil of the payment card is further configured to be inductively coupled to the corresponding charging coil of the computing device when the charging coil of the payment card is aligned with the corresponding charging coil of the computing device.

7. The payment card of claim 6, wherein an alignment component is configured to align the charging coil of the payment card and the corresponding charging coil of the computing device.

8. The payment card of claim 7, wherein the alignment component comprises a ferromagnetic component.

9. The payment card of claim 7, wherein the alignment component comprises a sleeve configured to be adhesively attached to the computing device.

10. The payment card of claim 7, wherein the alignment component comprises a case configured to protect the computing device.

11. The payment card of claim 1, further comprising a wireless charging component configured to regulate electrical energy generated by the charging coil of the payment card.

12. The payment card of claim 1, wherein the wireless communication protocol is a Bluetooth low-energy protocol.

13. A method of wirelessly reconfiguring a payment card, the method comprising:
aligning, via an alignment component of the payment card, a charging coil of the payment card with a corresponding charging coil of an external power source.
receiving, via the charging coil of the payment card, electrical energy from the corresponding charging coil of the external power source;
providing, via a wireless charging component of the payment card, the received electrical energy to a wireless communications component of the payment card;
coupling the wireless communications component of the payment card to a computing device;
receiving, via the wireless communications component of the payment card, a communication from the computing device; and
reconfiguring, via a programmable component of the payment card, the payment card based on the received communication from the computing device.

14. The method of claim 13, wherein the alignment component comprises at least one of a ferromagnetic component, a sleeve configured to be adhesively attached to the computing device, and a case configured to protect the computing device, or combinations thereof.

15. The method of claim 13, wherein the communication comprises an Application Protocol Data Unit (“APDU”) command.

16. The method of claim 15, further comprising:
generating, via the programmable component of the payment card, an APDU response configured to respond to the APDU command; and
transmitting, via the wireless communications component of the payment card, the generated APDU response to the computing device.

17. A system, the system comprising:
a computing device comprising a processor and a memory configured to store an application that, when executed by the processor, causes the computing device to detect an available configuration update; and
a payment card, wherein the payment card comprises:
a charging coil configured to generate electrical energy in response to a magnetic field generated by the computing device;
a wireless communication circuit electrically coupled to the charging coil, wherein the charging coil is configured to power the wireless communication circuit to receive the detected configuration update from the computing device via a wireless communication protocol; and
a programmable component reconfigurable by the configuration update.

18. The system of claim 17, wherein the payment card further comprises an alignment component configured to align the charging coil of the payment card with a corresponding charging coil of the computing device.

19. The system of claim 18, wherein the alignment component comprises at least one of a ferromagnetic component, a sleeve configured to be adhesively attached to the computing device, and a case configured to protect the computing device, or combinations thereof.

20. The system of claim 17, wherein the configuration update comprises an Application Protocol Data Unit (“APDU”) command.
